(19) United States
(12) Patent Application Publication
(10) Pub. No.: US 2008/0221234 A1
(43) Pub. Date: Sep. 11, 2008

(54) Acrylated Polyamide-Containing Printing Inks

(75) Inventors: Derek R. Illsley, Kent (GB); Martin J. Thompson, Kent (GB); Sean P. Mayers, Kent (GB); John Wilson, Kent (GB)

Correspondence Address: DICKSTEIN SHAPIRO, 1177 AVENUE OF THE AMERICAS (6TH AVENUE), NEW YORK, NY, 10036-2714, US

(73) Assignee: Sun Chemical Corp., Parsipanny, NJ (US)

(21) Appl. No.: 12/066,079

(22) PCT Filed: Sep. 7, 2006
(86) PCT No.: PCT/US06/34895

§ 371 Date: Mar. 6, 2008

(30) Foreign Application Priority Data
Sep. 7, 2005 (GB) 0518275.3

(51) Int. Cl. C08F 2/46

(52) U.S. Cl. 522/88; 522/176

(57) ABSTRACT

The problem of misting in printing inks may be cured by using as the oligomer in an energy-curable printing ink a radiation-curable acrylate-modified aminoamide resin which is the Michael addition product of a polyol ester having at least two (meth)acrylate ester groups with an aminoamide thermoplastic polymer, the aminoamide thermoplastic polymer being the reaction product of a polyamine with an acid component which comprises a polymerised unsaturated fatty acid and a C2-C22 fatty acid, from 1 to 25% of the acid functionality forming the aminoamide polymer being said C2-C22 fatty acid, the resin being liquid at 25° C.

The present invention relates to a series of new acrylate-modified polyamide resins and provides processes for their preparation and methods and compositions using them, especially for use in printing inks, and particularly for inks printable by offset lithography.

Acrylated polyamide oligomers are used as a component of many types of coating composition, such as printing inks, varnishes and the like. We have now discovered that the incorporation of fatty acids into such oligomers can reduce the problem, well known in the printing industry, of misting.

“Misting” is the term popularly applied to the formation of small airborne droplets of ink which are ejected from the rotating rollers of printing machines. As printing machines have begun to operate at increasingly high speeds, the problem of misting has got worse. Misting not only wastes ink, it represents a health hazard to workers in the printing industry and requires extraordinary measures in order to keep printing presses and the rooms in which they are housed clean.

Many workers have investigated the problem and many solutions have been proposed. Some of these are described, for example, in Newspaper Techniques, April 2002, 52-54; GATFWorld, March/April 1996, 8(2), 11,12; “Factors affecting the misting of UV curable inks”, Hutchinson I D; Richards A M [Paper presented at RadTech Europe, Maastricht, 25-27 Sep. 1995, 231-241]; American Ink Maker, March 1979, 57(3), 47,48,52,54,108-112. As can be seen, for example, in the last of these documents, a large number of factors are implicated in misting and many different expedients have been adopted in an effort to reduce or eliminate it, including altering process variables, environmental conditions and various elements of the ink composition.

We have surprisingly found that misting may be reduced or even eliminated by the use of a specifically formulated acrylated aminoamide oligomer.

EP 0 505 031 A2 describes and claims a series of aminoamide acrylate polymers which are curable by actinic radiation and which are said to be useful as hot melt adhesives. The polymers described in this specification are all solids with a very high molecular weight, which gives a low acrylate density, making them unsuitable as a sole vehicle in a lithographic printing ink since the cure would not be sufficient. However, by preparing polymer resins similar to these but which are liquid at room temperature, we have found that they may be incorporated into printing inks and that inks incorporating these resins are resistant to misting.

Thus, the present invention consists in a printing ink comprising a cross-linkable component and a photoinitiator, wherein the cross-linkable component comprises at least one radiation-curable acrylate-modified aminoamide resin which is the Michael addition product of a polyol ester having at least two (meth)acrylate ester groups with an aminoamide thermoplastic polymer, the aminoamide thermoplastic polymer being the reaction product of a polyamine with an acid component which comprises a polymerised unsaturated fatty acid and a monofunctional C₂- C₂₂ fatty acid, from 1 to 25% of the acid functionality forming the aminoamide polymer being said C₂-C₂₂ fatty acid, the resin being liquid at 25° C.

The aminoamide polymer, which is the starting material for the preparation of the resin of the present invention, is the reaction product of a polymerised unsaturated fatty acid and a monofunctional C₂-C₂₂ fatty acid with a polyamine, preferably a diamine.

Dimer acid is, as is well known to those skilled in the field of resins, a polymeric fatty acid, or, more commonly, mixture of polymeric fatty acids, prepared by polymerisation of unsaturated fatty acids, commonly obtained from tall oil. Although the major part of such dimer acids is composed of one or more dibasic acids, they typically also contain small amounts of monobasic acids (for example, the material used in the Examples hereof contains about 0.2% monobasic fatty acids) and small amounts of tri- and higher basic acids. If desired, the polymerised product may be separated into its components, but, more usually, the mixture of acids obtained from the polymerisation is used, as is. Hydrogenated dimer acids may also be employed. Where the polymerised fatty acid contains monobasic acid, this is not counted towards the amount of monofunctional C₂-C₂₂ fatty acid required in accordance with the present invention.

In general, the diamine is preferably an aliphatic, cycloaliphatic or aromatic diamine having from 2 to 36 carbon atoms. Examples of such diamines which may be employed include: aliphatic diamines having from 1 to 36 carbon atoms, such as methylenediamine, ethylenediamine, trimethylenediamine, hexamethylenediamine, methylpentamethylenediamine and polyether diamines; aromatic diamines having from 6 to 20 carbon atoms, such as toluenediamine, p,p′-diaminodiphenylmethane, and xylenediamine; cycloaliphatic diamines, such as diaminocyclohexane; and heterocyclic diamines, such as piperazine, 4,4′-dipiperidinyl, and aminoethylpiperazine. In addition, tri- and higher amines may be used, but preferably only in combination with one or more diamines and preferably in sufficiently small amounts as to prevent or minimise premature gelation. Examples of such polyamines include diethylenetriamine, triethylenetetramine, tetraethylenepentamine and bishexamethylenetriamine.

Of the diamines, we especially prefer to use piperazine, and a polyamide prepared by the reaction of dimer acid with piperazine is most preferred.

In accordance with the present invention, we have surprisingly found that the incorporation of a minor amount of a monofunctional fatty acid into the polyamide substantially reduces, and may even enable the elimination of, misting during a printing process using an ink based on the oligomer prepared from the polyamide. The monofunctional fatty acid should contain from 2 to 22 carbon atoms, preferably from 4 to 20, and more preferably from 6 to 20, carbon atoms. The acid may be a straight or branched chain compound and may be saturated or unsaturated. Examples of suitable acids include lauric acid, linseed oil fatty acid, tall oil fatty acid, pelargonic acid, octanoic acid, coconut oil fatty acid, soya bean oil fatty acid, olive oil fatty acid, peanut oil fatty acid, cottonseed oil fatty acid, capric acid, myristic acid, palmitic acid, stearic acid, palmitoleic acid, oleic acid, linoleic acid, linoleniic acid, eleostearic acid, ricinoleic acid, hexanoic acid or a mixture of any two or more thereof.

The monofunctional fatty acid should provide from 1 to 25% of the acid functionality in the polymerised unsaturated fatty acid/monofunctional fatty acid/polyamine system. Preferably, the monofunctional fatty acid provides from 3 to 20%, more preferably from 4.5 to 20%, of that functionality. If the polymerised fatty acid contains any monofunctional acids, those are not counted towards the amount of 1-25, 3-20 or 4.5-20, respectively. The inclusion of the monofunctional fatty acid can have a significant effect on the viscosity of the final product, and, as is well known in the art, it is important to maintain a careful control over the viscosity of printing inks. Thus, although the ranges specified are appropriate in general, for any specific formulation, it may be necessary to select the amount of fatty acid from a narrower range. For example, when the acrylate is trifunctional glycerol propoxylate triacrylate (GPTA), more than 10% of acid functionality from a monofunctional fatty acid gives a final polyamide acrylate with an unacceptably low viscosity. Conversely, when the acrylate is tetrafunctional polyalkoxylated pentaerythritol tetraacrylate (PPTA) anything less than 15% of acid functionality from a fatty acid gives a final polyamide acrylate with an unacceptably high viscosity.

The reaction between an acid and a polyamine is well known and may be carried out under well known conditions. The reaction is preferably carried out in the presence of a solvent suitable for forming an azeotrope with water. Otherwise, the nature of the solvent is not critical to the invention, provided that it has no adverse effect on the reaction or on the reagents involved. Examples of suitable solvents include aromatic hydrocarbons, such as xylene, toluene or benzene. There is equally no particular restriction on the reaction temperature; however, the reaction is preferably carried out at a temperature greater than 100° C., so as to remove the water formed during the reaction.

The polyamide so prepared should preferably have an amine number of from 40 to 60 mgKOH/g, and the amounts of polyamine and polycarboxylic acid used should be so chosen as to achieve a product having such an amine number. If necessary, the progress of the reaction may be monitored, as is well known in the art, so as to enable the reaction to be terminated when the required amine number has been achieved. Preferably the aminoamide thermoplastic polymer has an amine number of from 45 to 55 mgKOH/g, more preferably about 50 mgKOH/g.

This polyamide is then reacted with a polyol ester having at least two (meth)acrylate ester groups. The expression “(meth)acrylate” is used herein to mean “acrylate or methacrylate or a mixture thereof”. The polyol ester should have at least 2, preferably at least 3, and more preferably from 3 to 6 such (meth)acrylate ester groups. More preferably the polyol ester is an acrylate with a functionality of 3 or 4.

Preferably the polyol ester is an acrylate or methacrylate of a C₂-C₂₀ aliphatic or cycloaliphatic polyol.

Examples of suitable-polyol esters include: tripropyleneglycol diacrylate, dipropyleneglycol diacrylate, diethyleneglycol diacrylate, propoxylated neopentylglycol diacrylate, diacrylates of polyethyleneglycol (e.g. PEG200 diacrylate), hexanediol diacrylate, glycerol triacrylate, glycerol trimethacrylate, sorbitol triacrylate, sorbitol trimethacrylate, trimethylolethane triacrylate, trimethylolethane trimethacrylate, trimethylolpropane triacrylate, dimethylolpropane tetraacrylate, dimethylolpropane tetramethacrylate, trimethylolpropane trimethacrylate, ethoxylated trimethylolpropane triacrylate, ethoxylated trimethylolpropane trimethacrylate, glycerol propoxylate triacrylate, glycerol propoxylate trimethacrylate, pentaerythritol triacrylate, pentaerythritol trimethacrylate, pentaerythritol tetraacrylate, pentaerythritol tetramethacrylate, dipentaerythritol hexaacrylate, dipentaerythritol hexamethacrylate, ethoxylated pentaerytliritol tetraacrylate, propoxylated pentaerythritol tetraacrylate, sucrose pentaacrylate, sucrose pentamethacrylate, sucrose tetraacrylate, sucrose tetramethacrylate, sucrose triacrylate and sucrose trimethacrylate, of which glycerol propoxylate triacrylate is most preferred.

The Michael reaction between the polyamide and the polyol ester is a well known reaction and may be carried out under well known conditions. The reaction will often take place readily at ambient temperature. However, if desired, somewhat elevated temperatures may be employed, for example, a temperature from 20 to 100, more preferably from 20 to 70° C.

The polyol ester is preferably employed in an amount in excess of the simple stoichiometric amount needed to react with all of the free amine groups in the polyamide, so that unreacted acrylate groups are left in the reaction mixture.

The ratio of the initial (meth)acrylate groups of the polyol ester to the initial amino functional groups of the aminoamide polymer is preferably at least 4:1. More preferably this ratio is at least 8:1, still more preferably greater than 8:1 and no more than 30:1, still more preferably greater than 8:1 and no more than 20:1, and most preferably greater than 8:1 and no more than 15:1.

The printing ink of the present invention is preferably formulated for offset lithography.

The printing ink of the present invention comprises at least a photoinitiator and a polymerisable resin of the present invention. In addition, it may contain any one or more of other well known materials which are commonly incorporated into such compositions to provide particular desired properties either in the curable composition or in the final cured product, and, in particular, will normally contain a pigment or other colorant.

Non-limiting examples of such other components are as follows:

### Monomers and Oligomers

The printing ink may, if desired, contain other radiation-curable monomers and/or oligomers. Examples of suitable acrylate oligomers include aliphatic or aromatic urethane acrylates, polyether acrylates, polyester acrylates and epoxy acrylates (such as bisphenol A epoxy acrylate). Examples of suitable acrylate monomers include hexanediol diacrylate, trimethylolpropane triacrylate, di-trimethylolpropane tetraacrylate, di-pentaerythritol pentaacrylate, polyether acrylates, such as ethoxylated trimethylol propane triacrylate, glycerol propoxylate triacrylate, ethoxylated pentaerythritol tetraacrylate, and epoxy acrylates such as dianol diacrylate (=the diacrylate of 2,2-bis[4-(2-hydroxyethoxy)phellyl]propane, Ebecryl 150 from UCB) and glycol diacrylates such as tripropylene glycol diacrylate.

### Initiators

The printing ink of the present invention will contain, in addition to the resin of the present invention, a photoinitiator. Such initiators are well known in the art, and there is no particular restriction on the choice of initiator for use in the present invention.

In general, a blend of several photoinitiators and an anime synergist are preferably used to achieve the desired balance of product properties. The photoinitiators may be of either the cleavage or hydrogen abstraction type and are preferably selected from the following photoinitiator classes: benzophenones, thioxanthones, hydroxyalkylphenones, aminoalkylphenones, antlraquinones, acyl phosphine oxides, bis-acyl phosphine oxides, benzil ketals, benzoin ethers, acetophenones, beta ketosulphones, oxime esters and phenyl glyoxic acid esters. The amine synergists are preferably selected from the classes of aliphatic amines, aminoacrylates or esters of 4-dimethylaminobenzoic acid. Sensitisers such as Michler's ketone or its analogues may also be used.

Further examples of photoinitiators, synergists and sensitisers can be found in standard textbooks such as “Chemistry & Technology of UV & EB Formulation for Coatings, Inks & Paints”, Volume III, “Photoinitiators for Free Radical Cationic and Anionic Polymerisation”, 2^{nd} edition, by J. V. Crivello & K. Dietliker, edited by G. Bradley and published in 1998 by John Wiley & Sons in association with SITA Technology Limited; and “Exploring the Science, Technology and Applications of UV and EB Curing”, R. S. Davidson, SITA Technology Ltd., London, 1999, the disclosures of which are incorporated herein by reference.

### Pigments and Other Colorants

In the context of the present invention, the term ‘colorant’ covers both materials which endow an actual visual colour and/or another optical property such as fluorescence. Colorants are typically included in amounts of about 20% of total colorant(s) by weight of the total composition.

Broadly speaking, colorants may be considered as falling into two classes, nanmely dyes, which are substantially soluble in the ink composition, and pigments, which are dispersed in the ink composition in the form of fine particles, if necessary with the aid of a suitable dispersant. Pigments may be selected from a wide range of classes, for example, Pigment Red 57:1, Pigment Red 52:2, Pigment Red 48:2, Pigment Blue 15:3, Pigment Green 7, Pigment Yellow 83, Pigment Yellow 13, Pigment White 6, Pigment Black 7. A non-exhaustive list of examples of such pigments include the following from the lrgalite range ex CIBA: Rubine L4, Bordeaux CM, Red 2BP, Blue LG, Green GLN, Yellow B3R and yellow LBG; as well as Tioxide RHD6 (ex Tioxide) and Special Black 250 (ex Degussa). Other examples of suitable pigments are given in “Printing Ink Manual”, fourth edition, Leach R. H. et al. (eds.), Van Nostrand Reinhold, Wokingham, (1988), the disclosure of which is incorporated herein by reference.

### Other Additives

Printing ink compositions according to the present invention optionally may also comprise one or more minor ingredients, for example, surfactants, levelling additives, photoinitiator stabilisers, wetting agents and pigment stabilisers. The latter may for example be of polyester, polyurethane or polyacrylate types, especially in the form of high molecular weight block co-polymers, and would typically be incorporated at from 2.5% to 100% by weight of the pigment. Suitable examples are Disperbyk 161 or 162 (ex BYK Chemie) or Solsperse ex Zeneca. Suitable photoinitiator stabilisers include those disclosed in EP-A-0 465 039.

Suitable surfactants are preferably of the non-ionic type, for example Fluorad FC430 (ex 3M Corp.). Such surfactants (when present) are preferably included in an amount of 0.1% to 10% by weight of the total composition.

The amount of the acrylated polyamide used in the printing ink of the present invention may vary over a wide range, as is well known in the art. In general terms, for printing ink compositions, we prefer that the amount should be between 15 and 70%, more preferably 20 to 60%, and most preferably 25-45%.

The application and curing of the compositions of the present invention may be carried out using techniques well known to those skilled in the art, for example, as described in “Printing Ink Manual”, fourth edition, referred to above.

The invention is further illustrated by the following non-limiting Examples.

### EXAMPLE 1

### Preparation of Acrylated Polyamide Resin

Dimer acid (Pripol 1013 ex Uniqema, 157.2 g, 0.561 equivalents) nonanoic acid (4.7 g, 0.030 equivalents) and piperazine (33 g, 0.767 equivalents) were charged into a reaction vessel with sufficient toluene for azeotropic distillation and heated to 120° C. with a nitrogen sparge. The reaction was held at 120° C. until the amine was fixed, and the mixture was then heated to 190° C. and held until all water of reaction had been removed. A sample of the product was titrated with HCl to bromocresol green end-point to show an amine value of 50 mgKOH/g. The reaction vessel was then cooled to 60° C. and glycerol propoxylate triacrylate (OTA 480 ex UCB 301 g, 1.88 equivalents) added with a small quantity of inhibitor (butylated hydroxytoluene (BHT), 0.5 g). The reaction was held at 60° C. until the Michael addition had finished. The product was a yellow liquid of viscosity 60 Poise at 25° C.

### EXAMPLE 2

### Preparation of Acrylated Polyamide Resin

Dimer acid (Pripol 1013 ex Uniqema, 126.8 g, 0.453 equivalents) octanoic acid (3.4 g, 0.023 equivalents) and piperazine (26.6 g, 0.619 equivalents) were charged into a reaction vessel with sufficient toluene for azeotropic distillation and heated to 120° C. with a nitrogen sparge. The reaction was held at 120° C. until the amine was fixed, and the mixture was then heated to 190° C. and held until all water of reaction had been removed. A sample of the product was titrated with HCl to bromocresol green end-point to show an amine value of 50 mgKOH/g. The reaction vessel was then cooled to 60° C. and glycerol propoxylate triacrylate (OTA 480 ex UCB 242.8 g, 1.518 equivalents) added with a small quantity of inhibitor (BHT, 0.4 g). The reaction was held at 60° C. until the Michael addition had finished. The product was a yellow liquid of viscosity 70 Poise at 25° C.

### COMPARATIVE EXAMPLE 1

Preparation of Acrylated Polyamide Resin

Dimer acid (Pripol 1013 ex Uniqema, 82.73 g, 0.295 equivalents) and piperazine (16.5 g, 0.384 equivalents) were charged to a reaction vessel with sufficient xylene for azeotropic distillation and heated to 120° C. with a nitrogen sparge. The reaction was held at 120° C. until the amine was fixed, and the mixture was then heated to 190° C. and held until all water of reaction had been removed. A sample of the product was titrated with HCl to bromocresol green end-point to show an amine value of 50 mgKOH/g. The reaction vessel was then cooled to 60° C. and glycerol propoxylate triacrylate (OTA 480 ex UCB 150.52 g, 0.94 equivalents) added with a small quantity of inhibitor (BHT, 0.25 g). The reaction was held at 60° C. until the Michael addition had finished. The product was a yellow liquid of medium viscosity.

### EXAMPLE 3

### Preparation of Cyan Ink

A standard UV cyan ink was made up with polyester acrylates (50 g Ebecryl 657 and 50 g Ebecryl 870, both ex UCB), epoxy acrylate (CN104 ex Sartomer 10 g), acrylated monomers (GPTA, OTA 480 ex UCB 10 g and dianol diacrylate 20 g), pigment (Phthalocyanine blue pigment, Sunfast blue ex Sun Chemical 36 g), talc (4 g), wax (2 g) and photoinitiator (18 g made up of 25% benzophenone, 25% isopropylthioxanthone, and 50% of 2-ethylhexyl-4-dimethylaminobenzoate) on a 3 roll mill.

A second ink was prepared in the same manner with all the acrylated oligomer components (110 g) replaced by a polyamide acrylate made according to Example 1.

A third ink was prepared in the same manner with all the acrylated oligomer components (110 g) replaced by a polyamide acrylate made according to Comparative Example 1 (in which the fatty acid was omitted).

All three inks were of similar viscosity (90 Poise at 32° C.) and found to have equivalent cure, but the ink made with the fatty acid modified polyamide acrylate of Example 1 had superior misting when measured in the following manner. 1.3 cc of ink was evenly distributed on a Tackoscope (Testprint bv The Netherlands), a sheet of paper was affixed under the rollers so as to collect any ink, mist from the rollers which were then rotated at 600 rpm for 30 seconds. Misting was assessed by visual inspection of the paper.

1. A printing ink comprising a cross-linkable component and a photoinitiator, wherein the cross-linkable component comprises at least one radiation-curable acrylate-modified aminoamide resin which is the Michael addition product of a polyol ester having at least two (meth)acrylate ester groups with an aminoamide thermoplastic polymer, the aminoamide thermoplastic polymer being the reaction product of a polyamine with an acid component which comprises a polymerised unsaturated fatty acid and a C₂-C₂₂ fatty acid, from 1 to 25% of the acid functionality forming the aminoamide polymer being said C₂-C₂₂ fatty acid, the resin being liquid at 25° C.

2. A printing ink according to claim 1, in which said fatty acid is C₄-C₂₀.

3. A printing ink according to claim 1, in which said fatty acid is C₆-C₂₀.

4. A printing ink according to claim 1, in which said fatty acid is selected from the group consisting of lauric acid, linseed oil fatty acid, tall oil fatty acid, pelargonic acid, octanoic acid, coconut oil fatty acid, soya bean oil fatty acid, olive oil fatty acid, peanut oil fatty acid, cottonseed oil fatty acid, capric acid, myristic acid, palmitic acid, stearic acid, palmitoleic acid, oleic acid, linoleic acid, linolenic acid, eleostearic acid, ricinoleic acid, hexanoic acid and a mixture of any two or more thereof.

5. A printing ink according to claim 1, in which said fatty acid is octanoic acid or nonanoic acid.

6. A printing ink according to claim 1, in which the fatty acid comprises from 3 to 20% of the acid functionality of the acid component.

7. A printing ink according to claim 1, in which the fatty acid comprises from 4.5 to 20% of the acid functionality of the acid component.

8. A printing ink according to claim 1, in which said polyol ester has at least three (meth)acrylate groups.

9. A printing ink according to claim 8, in which the polyol ester is an acrylate with a functionality of 3 or 4.

10. A printing ink according to claim 1, in which the polyol ester is an acrylate or methacrylate of a C₂-C₂₀ aliphatic or cycloaliphatic polyol.

11. A printing ink according to claim 10, in which the polyol ester is selected from the group consisting of glycerol triacrylate, glycerol trimethacrylate, sorbitol triacrylate, sorbitol trimethacrylate, trimethylolethane triacrylate, trimethylolethane trimethacrylate, trimethylolpropane triacrylate, dimethylolpropane tetraacrylate, dimethylolpropane tetramethacrylate, trimethylolpropane trimethacrylate, ethoxylated trimethylolpropane triacrylate, ethoxylated trimethylolpropane trimethacrylate, glycerol propoxylate triacrylate, glycerol propoxylate trimethacrylate, pentaerythritol triacrylate, pentaerythritol trimethacrylate, pentaerythritol tetraacrylate, pentaerythritol tetramethacrylate, dipentaerythritol hexaacrylate, dipentaerythritol hexamethacrylate, ethoxylated pentaerythritol tetraacrylate, propoxylated pentaerythritol tetraacrylate, sucrose pentaacrylate, sucrose pentamethacrylate, sucrose tetraacrylate, sucrose tetramethacrylate, sucrose triacrylate and sucrose trimethacrylate.

12. A printing ink according to claim 10, in which the polyol ester is glycerol propoxylate triacrylate.

13. A printing ink according to claim 1, in which the aminoamide polymer is a reaction product of a polymerised unsaturated fatty acid with a diamine.

14. A printing ink according to claim 13, in which the polymerised unsaturated fatty acid is a dimer acid.

15. A printing ink according to claim 13, in which the diamine is an aliphatic, cycloaliphatic or aromatic diamine having from 2 to 36 carbon atoms.

16. A printing ink according to claim 15, in which the diamine is selected from the group consisting of ethylenediamine, propylenediamine, trimethylenediamine, tetramethylenediamine, hexamethylenediamine, methylpentamethylenediamine, diaminocyclohexane, piperazine, 4,4′-dipiperidinyl, toluene-2,4-diamine and p,p′-diaminodiphenylmethane.

17. A printing ink according to claim 15, in which the diamine is piperazine.

18. A printing ink according to claim 1 in which the aminoamide thermoplastic polymer has an amine number of from 40 to 60 mgKOH/g.

19. A printing ink according to claim 1, in which the aminoamide thermoplastic polymer has an amine number of from 45 to 55 mgKOH/g.

20. A printing ink according to claim 1, in which the aminoamide thermoplastic polymer has an amine number of about 50 mgKOH/g.

21. A printing ink according to claim 1, in which the ratio of the initial (meth)acrylate groups of the polyol ester to the initial amino functional groups of the aminoamide polymer is at least 4:1.

22. A printing ink according to claim 1, in which the ratio of the initial (meth)acrylate groups of the polyol ester to the initial amino functional-groups of the aminoamide polymer is at least 8:1.

23. A printing ink according to claim 22, in which the ratio of the initial (meth)acrylate groups of the polyol ester to the initial amino functional groups of the aminoamide polymer is greater than 8:1 and no more than 30:1.

24. A printing ink according to claim 23, in which the ratio of the initial (meth)acrylate groups of the polyol ester to the initial amino functional groups of the aminoamide polymer is greater than 8:1 and no more than 20:1.

25. A printing ink according to claim 24, in which the ratio of the initial (meth)acrylate groups of the polyol ester to the initial amino functional groups of the aminoamide polymer is greater than 8:1 and no more than 15:1.

26. A printing ink according to claim 1, formulated for lithographic printing.

27. A printing ink according to claim 13, in which the polymerised unsaturated fatty acid is a dimer acid.
